(19) United States
(12) Patent Application Publication
(10) Pub. No.: US 2014/0308737 A1
(43) Pub. Date: Oct. 16, 2014

(54) METHODS OF EXTRACTING PECTIN FROM CITRUS PEEL

(71) Applicant: Citrus Pectin Products, Inc., Allen, TX (US)

(72) Inventor: Thomas Laaman, Madbury, NH (US)

(21) Appl. No.: 14/213,205

(22) Filed: Mar. 14, 2014

Related U.S. Application Data
(60) Provisional application No. 61/791,810, filed on Mar. 15, 2013.

(51) Int. Cl. C08B 37/00

(52) U.S. Cl. CPC C08B 37/0048
USPC 435/275; 536/2

(57) ABSTRACT

In various implementations, methods may be implemented to extract pectin from citrus peel. The methods may include using a mild organic acid, an enzyme, or a mild organic acid/enzyme combination, to extract at least a portion of the pectin from the citrus peel. The methods may further include using high temperature and a short extraction time. In some implementations, no additional water is added, other than the water necessary to originally prime the system. The methods may further involve pressing the citrus peel or fruit waste to reduce the moisture content before adding the acid, enzyme, or acid/enzyme combination. In some implementations, the extracted pectin may be provided as a concentrated liquid or may be combined with cellulose and/or hemi-cellulose to form a composite ingredient.

### CROSS-REFERENCE TO RELATED APPLICATION

This application claims priority to U.S. Provisional Patent Application No. 61/791,810, entitled “METHODS OF EXTRACTING PECTIN FROM CITRUS PEEL”, filed on Mar. 15, 2013, which is hereby incorporated by reference for all purposes.

### TECHNICAL FIELD

The present disclosure relates to methods of extracting pectin from citrus peel.

### BACKGROUND

The process of manufacturing pectin and other hydrocolloids often involves using chemicals, such as mineral acids and alcohol solvents, to enhance pectin extraction and gain product purity. These harsh chemicals are damaging to the environment. There are also environmental concerns associated with the disposal of raw material residue following pectin extraction.

The citrus producing states (Florida, California, and Texas) at one time had production facilities to manufacture pectin from citrus peel. However, the negative environmental impact associated with the manufacturing process largely caused the cessation of pectin production in the United States, even though domestic pectin demand is increasing. As a result, food manufacturers are being forced to import pectin from foreign sources, thus saddling the United States food industry with skyrocketing prices made worse by import fees.

### SUMMARY

In various implementations, methods may be implemented to extract pectin from citrus peel. The methods may include using a mild organic acid, an enzyme, or a mild organic acid/enzyme combination, to extract at least a portion of the pectin from the citrus peel. The methods may further include using high temperature and a short extraction time. In some implementations, no additional water is added, other than the water necessary to originally prime the system. The methods may further involve pressing the citrus peel or fruit waste to reduce the moisture content before adding the acid, enzyme, or acid/enzyme combination.

In some implementations, the extracted pectin, as well as the cellulose and hemi-cellulose from the citrus peel may be used in the pectin extraction facility to produce beverages and foods. In some implementations, the extracted pectin may be separated from the solid cellulose, hemi-cellulose and residual pectin and provided as a concentrated liquid. In some implementations, the pectin and solid residual products (cellulose, hemi-cellulose) may be provided as a composite ingredient.

Embodiments of the present disclosure generally provide a process for extracting at least a portion of pectin from a raw material, the process may include mixing the raw material and an extraction agent to form a mixture, heating the mixture to a target temperature, and maintaining the mixture under heat for a target extraction time wherein the pectin is then extracted. The extraction agent may be selected from the group including a mild organic acid, an enzyme, and a combination of a mild organic acid and an enzyme. The mild organic acid may be citric acid or malic acid and the enzyme may be a polygalacturonase-based enzyme. The target temperature may be approximately 100° Celsius. The target extraction time may be up to about 120 minutes. The mixture may have a moisture content of at least about 60%. The process may further include separating concentrated liquid pectin from a solid residue of cellulose, hemi-cellulose and residual pectin in the mixture.

Embodiments of the present disclosure may further provide a process for extracting pectin from a raw material, the process may include pressing the raw material to decrease moisture content, mixing the raw material and an extraction agent to form a mixture of extracted pectin, and drying the mixture. The extraction agent may be selected from the group including a mild organic acid, an enzyme, and a combination of a mild organic acid and an enzyme. The mild organic acid may be citric acid or malic acid and the enzyme may be a polygalacturonase-based enzyme. The process may further include heating the mixture to a target temperature before drying the mixture. The target temperature may be approximately 100° Celsius. The process may further include maintaining the mixture under heat for a target extraction time. The target extraction time may be up to about 120 minutes.

Other embodiments of the present disclosure may provide a process for extracting pectin from a raw material, the process may include removing seeds, stems, oils and sugars from the raw material; pressing the raw material to decrease moisture content; mixing the raw material and an extraction agent to form a mixture of extracted pectin, the extraction agent may be selected from the group including a mild organic acid, an enzyme, and a combination of a mild organic acid and an enzyme; drying the mixture; heating the mixture to a target temperature; and maintaining the mixture under heat for a target extraction time. The mild organic acid may be citric acid or malic acid, and the enzyme may be a polygalacturonase-based enzyme. The mixture may have a moisture content of at least about 60%. The mixture may have a moisture content of at least about 60%. The process may further include separating concentrated liquid pectin from a solid residue of cellulose, hemi-cellulose and residual pectin in the mixture.

The details of one or more implementations are set forth in the description below. Other features, objects, and advantages of the implementations will be apparent from the description.

### BRIEF DESCRIPTION OF THE DRAWINGS

For a more complete understanding of this disclosure and its features, reference is now made to the following description, taken in conjunction with the accompanying drawings, in which:

FIG. 1 is a flow diagram illustrating a method of extracting pectin from a citrus peel in accordance with an embodiment of the present disclosure;

FIG. 2 is a flow diagram illustrating a method of extracting pectin from a citrus peel while minimizing moisture content in accordance with an embodiment of the present disclosure; and

FIG. 3 is another flow diagram illustrating a method of extracting pectin from a citrus peel while minimizing moisture content in accordance with an embodiment of the present disclosure.

### DETAILED DESCRIPTION

Pectin may be considered the most valuable compound in the hydrocolloid family at least because: 1) it is all natural without chemical modifications; 2) it can contribute both gelling properties and viscosity enhancement to foods; 3) pectin has been used by American homemakers for generations to make jams and jellies, and is therefore considered an American ingredient (instead of an unfamiliar foreign product) when listed on food labels; 4) pectin has been cited as having health benefits (such as providing protection against heart disease and cancer) because it is a soluble fiber and can lower cholesterol.

Citrus peel has the highest percentage of pectin of all biological materials. The United States is the second largest producer of citrus in the world. Historically, citrus peel has been converted to cattle feed in the United States. The resultant cattle feed is sold at a low price to areas of the world where grain is not plentiful. This conversion of citrus peel to cattle feed required the addition of calcium oxide to dissipate the moisture prior to drying. The process of producing cattle feed from citrus peel is damaging to the environment due to the emission of volatile organic compounds during the drying of peel fully burdened with citrus oils and d-limonene. There are other fruit processing operations throughout the world where valuable pectin is simply disposed of, often with negative environmental consequences, instead of being extracted for food. The cost of the primary fruit product is more expensive when the valuable pectin found in the by-products is not extracted.

Citrus peel contains vitamins, minerals, polyphenol antioxidants, and fiber (both soluble and insoluble). Cellulose and hemi-celluloses are also present. These elements provide nutritional as well as functional benefits to foods, including water binding, texture, and mouth feel.

Fruit juice manufacturers often make beverages in addition to juice. These beverages sometimes include the addition of hydrocolloids to attain the desired viscosity and mouth feel. If pectin were to be manufactured in the same plant where the juice is processed, it could be added to the beverage in a liquid form, thus avoiding the necessity of drying it first.

In various implementations, methods of extracting pectin from citrus peel are disclosed. Such methods may produce high quality, low cost pectin without the use of harsh chemicals, while minimizing or even eliminating the waste residues of citrus peel processing that are themselves major waste issues. These methods according to various implementations may allow pectin to again be manufactured in the United States and eliminate the need for expensive and unstable foreign pectin sources. This would in turn increase the amount of pectin available domestically, thus increasing the quality and nutritional value of foods made in the United States.

In various implementations, the methods for extracting pectin from citrus peel make possible the production of unique pectin containing products. Furthermore, the methods may enable the management of pectin containing raw materials. Conventional pectin containing products can also be made using the pectin derived from these methods.

FIG. 1 is a flow diagram illustrating method 10 for extracting pectin from a citrus peel according to one embodiment of the present disclosure.

Method 10 may begin in step 102 by using mild organic acids, including but not limited to citric acid and malic acid, enzymes, such as polygalacturonase-based enzymes, or mild organic acids combined with enzymes to effectuate a partial-to-complete extraction of pectin from citrus peel. The elimination of harsh non-biological acids may create a pectin processing protocol that is sensitive to environmental considerations. A partial extraction of pectin is justified when the raw material is present in abundance, the cost to extract the pectin is very low, the waste residue can be substantially reduced, and it is not damaged such that it can be utilized as a food ingredient.

The method may further comprise using high temperature (approximately 100 degrees Celsius), as shown in step 104, and a short extraction time to minimize the cost, as shown in step 106. It should be appreciated that the extraction time may be less than 30 minutes or may be as much as 120 minutes according to embodiments of the present disclosure. In some embodiments of the present disclosure, the extraction time may range from 0 to up to approximately 30 minutes. In other embodiments of the present disclosure, the extraction time may range from 0 to approximately 120 minutes. In further embodiments of the present disclosure, the extraction time may range from approximately 30 minutes up to approximately 120 minutes. However, it should be appreciated that longer extraction times will not harm the product and may even increase slightly the amount of pectin extracted.

The method may further comprise adding no water, other than that required to initially prime the system. This may allow for the conservation of water insofar as water normally found in the citrus peel or other fruit byproduct stream may be utilized. This reduces the cost of production, eliminates the wastewater stream and avoids the negative environmental impact usually associated with pectin production facilities. The extraction can take place effectively using the mild acid and heat at moisture contents of 60% to 99+%.

Additional features of the method may enable manufacturers to avoid using alcohol to isolate the pectin after it is extracted. The use of the “alcohol precipitation” method is a major reason why pectin has not recently been manufactured in the United States.

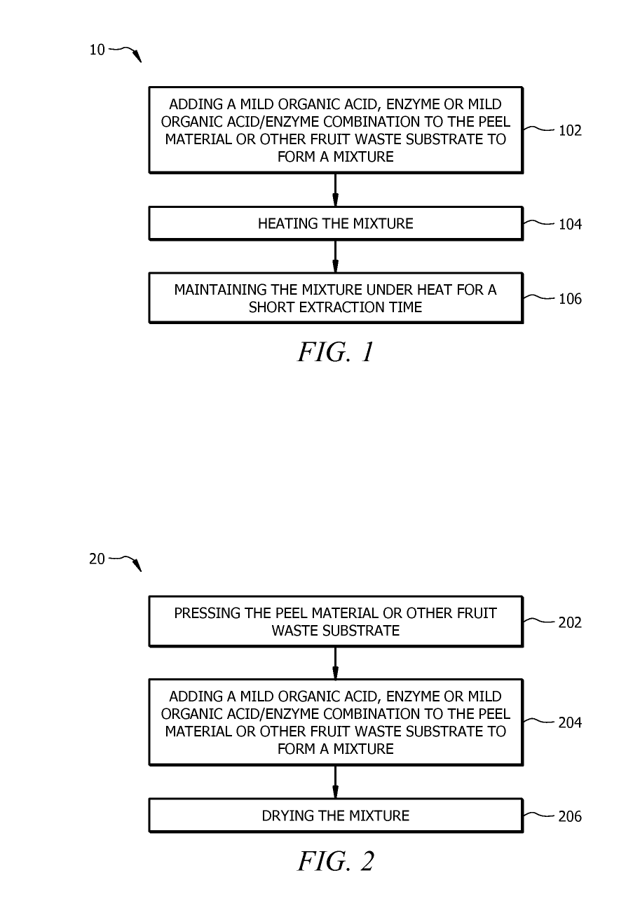

The method may further comprise minimizing moisture in the raw material (citrus peel or other fruit waste), as shown in FIG. 2. FIG. 2 is a flow diagram illustrating method 20 for extracting pectin from a citrus peel while minimizing moisture content according to an embodiment of the present disclosure.

Method 20 may begin in step 202 by pressing the peel or other fruit waste to reduce the moisture content. The method step of adding acid, enzyme, or acid/enzyme combination may be performed at this low moisture point, as shown in step 204. Once the extraction is completed, the pectin and residue together may be dried, as shown in step 206, and sold. The peel material or other fruit waste substrate should be substantially free of non-food items, such as seeds or stems, for example, and the undesirable flavor contributing components, such as bitter oils and sugars, for example, may be removed or minimized.

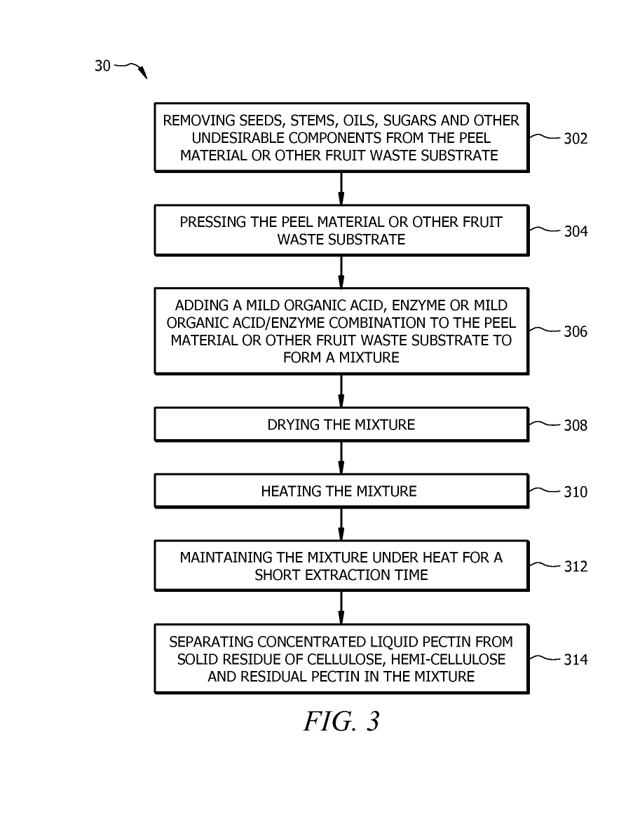

FIG. 3 is another flow diagram illustrating method 30 for extracting pectin from a citrus peel while minimizing moisture content according to one embodiment of the present disclosure.

Method 30 may begin in step 302 by removing undesirable components from the peel material or other fruit waste substrate. The peel material or other fruit waste substrate should be substantially free of non-food items, such as seeds or stems, for example, and the undesirable flavor contributing components, such as bitter oils and sugars, for example, may be removed or minimized. The peel or other fruit waste may then be pressed to reduce the moisture content, as shown in step 304. The method step of adding a mild organic acid, enzyme, or a mild organic acid/enzyme combination may be performed at this low moisture point, as shown in step 306. Once the extraction is completed, the pectin and residue together may be dried, as shown in step 308. The method may further comprise heating the mixture at a high temperature, as shown in step 310, and maintaining the mixture under heat for a short extraction time to minimize the cost, as shown in step 312.

In some implementations, the entire mass of extracted pectin, cellulose, and hemi-cellulose may be utilized in the same facility to produce value-added beverages and foods. This eliminates the need to dry the pectin before adding it to these food formulations. This also saves drying costs and keeps the pectin and other components ready to use in food systems.

In some implementations, the pectin may be provided as a concentrated liquid pectin after separating it from the solid residue of cellulose, hemi-cellulose, and residual pectin in the mixture, as shown in step 314. Because of the low pH and the heat used to extract the pectin, it will have long shelf stability at room temperature. The residue may also be used as a food product if the seeds, oils, sugars, and other undesirable components are substantially removed before the pectin extraction takes place.

Food naturally is a composite of many complex chemicals. Some of these complex components provide nutritional value (protein, vitamins, minerals, antioxidants), some of which make the food desirable to eat (flavors, colors, textures), and some of which allow the food to be stable and remain cohesive (hydrocolloids, structural protein, cellulose fibers). In the processed food industry, all these components may be added separately. In some implementations, the method of citrus peel extraction disclosed herein promotes the concept that for citrus peel and other fruit wastes, the pectin is best utilized in combination with the cellulose and hemi-cellulose that it is naturally entangled with in nature. Although the pectin is extracted from these other components to be functional, it need not be separated from them. Instead, it can be used as a composite ingredient to provide enhanced functional benefit (gelling, water binding, stabilizing) and nutritional benefit (soluble and insoluble fibers, vitamins, antioxidants).

It is to be understood the implementations are not limited to particular methods described which may, of course, vary. It is also to be understood that the terminology used herein is for the purpose of describing particular implementations only, and is not intended to be limiting. As used in this specification, the singular forms “a”, “an” and “the” include plural referents unless the content clearly indicates otherwise.

Although the present disclosure has been described in detail, it should be understood that various changes, substitutions and alterations may be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A process for extracting at least a portion of pectin from a raw material, the process comprising:
mixing the raw material and an extraction agent to form a mixture;
heating the mixture to a target temperature; and
maintaining the mixture under heat for a target extraction time wherein the pectin is then extracted.

2. The process of claim 1, wherein the extraction agent is selected from the group comprising:
a mild organic acid, an enzyme, and a combination of a mild organic acid and an enzyme.

3. The process of claim 2, wherein the mild organic acid is citric acid or malic acid.

4. The process of claim 2, wherein the enzyme is a polygalacturonase-based enzyme.

5. The process of claim 1, wherein the target temperature is approximately 100° Celsius.

6. The process of claim 1, wherein the target extraction time is up to about 120 minutes.

7. The process of claim 1, the mixture has a moisture content of at least about 60%.

8. The process of claim 1, further comprising:
separating concentrated liquid pectin from a solid residue of cellulose, hemi-cellulose and residual pectin in the mixture.

9. A process for extracting pectin from a raw material, the process comprising:
pressing the raw material to decrease moisture content;
mixing the raw material and an extraction agent to form a mixture of extracted pectin; and
drying the mixture.

10. The process of claim 9, wherein the extraction agent is selected from the group comprising:
a mild organic acid, an enzyme, and a combination of a mild organic acid and an enzyme.

11. The process of claim 10, wherein the mild organic acid is citric acid or malic acid.

12. The process of claim 10, wherein the enzyme is a polygalacturonase-based enzyme.

13. The process of claim 9, further comprising:
heating the mixture to a target temperature before drying the mixture.

14. The process of claim 13, wherein the target temperature is approximately 100° Celsius.

15. The process of claim 13, further comprising:
maintaining the mixture under heat for a target extraction time.

16. The process of claim 15, wherein the target extraction time is up to about 120 minutes.

17. A process for extracting pectin from a raw material, the process comprising:
removing seeds, stems, oils and sugars from the raw material;
pressing the raw material to decrease moisture content;
mixing the raw material and an extraction agent to form a mixture of extracted pectin, the extraction agent selected from the group comprising: a mild organic acid, an enzyme, and a combination of a mild organic acid and an enzyme;
drying the mixture;
heating the mixture to a target temperature; and
maintaining the mixture under heat for a target extraction time.

18. The process of claim 17, wherein the mild organic acid is citric acid or malic acid, and wherein the enzyme is a polygalacturonase-based enzyme.

19. The process of claim 17, the mixture has a moisture content of at least about 60%.

20. The process of claim 17, further comprising:
separating concentrated liquid pectin from a solid residue of cellulose, hemi-cellulose and residual pectin in the mixture.
